(19) United States
(12) Patent Application Publication
(10) Pub. No.: US 2003/0187889 A1
(43) Pub. Date: Oct. 2, 2003

(54) Functional gap average on-line randomness test

(75) Inventor: Laszlo Hars, Cortlandt Manor, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/106,950

(22) Filed: Mar. 26, 2002

(51) Int. Cl. G06F 1/02

(52) U.S. Cl. 708/250

(57) ABSTRACT

The present invention is a method and apparatus for testing the random numbers generated by a random-number generator in real time. A stream of random bits is generated using a random-number generator, then the generated random bits undergo a functional-exponential-average gap length calculation in which distances between occurrences of a plurality of sub-sequences having identical bit patterns are identified and applied to functional weighting and exponential averaging to obtain an average gap length. The average gap length is compared to a predetermined acceptance range, such that if the average gap length repeatedly falls outside the predetermined acceptance range more than a predetermined number of times, it is determined that the generated random bits are insufficiently random.

### BACKGROUND OF THE INVENTION

1. Field of the Invention

The present invention pertains to the field of random-number generators and, in particular, to a digital-data-processing apparatus and method for generating true binary random sequences.

2. Description of the Related Art

Many electronic devices are equipped with random-number generators for various random applications. Especially, random-number generators are fundamentally important in this computer age where randomness is critically important to ensure security. However, a truly random sequence is difficult to generate in real application. For example, heat is typically generated in the hardware component of the random-number generator when it generates a series of 1's and 0's over a time period. Generating a 1 bit could consume more power than a 0 bit. As such, if a long sequence of 1 bits is generated, the electrical circuit becomes hot causing the circuit to “latch up”, thereby generating mostly 1 bits but rarely a 0 bit. A different effect may occur when a 0 bit is generated while the circuit is hot. In this case a long sub-sequence of 1 bits becomes too rare. In random sequences where frequently long sub-sequences consist of equal bits of 0's or 1's, the biased 0/1 frequency error, as described in the preceding paragraphs, will have catastrophic consequences of breaching security.

The security of many applications depends on the actual randomness of the random number generation. Accordingly, both the detection of hardware tampering and a component failure are necessary when conducting randomness tests. Conventional randomness tests are performed through extensive statistical testing, such as chi-squared tests, delta tests, and the like, on a sequence of generated random numbers. However, such tests are very expensive to be performed in real time as they require a great amount of computational-processing power.

### SUMMARY OF THE INVENTION

The present invention overcomes the above-described problems, and provides additional advantages by providing a method and apparatus for providing an on-line randomness test to ensure that the generated random numbers are sufficiently random.

According an aspect of the invention, a method for testing randomness when generating a stream of random numbers includes the steps of: generating a continuous stream of random binary bits; applying the generated random bits to an exponential-functional-gap average calculation to compute a weighted average gap length between occurrences of identical bit patterns; and, determining whether the generated random bits are sufficiently random by comparing the output of the exponential-gap operation to a predetermined acceptance range, wherein the predetermined acceptance range is selected by an operator to achieve a desired security-threshold level. The method further includes the steps of: determining that the generated random bits are insufficiently random when the average gap length repeatedly falls outside the predetermined acceptance range more than a predefined number of times; notifying that the generated random bits are insufficiently random when the average gap length repeatedly falls outside the predetermined acceptance range more than a predefined number of times; generating a new set of random bits when the average gap length repeatedly falls outside the predetermined acceptance range more than a predefined number of times; and, denying the generated random bits for a subsequent application when the average gap length repeatedly falls outside the predetermined acceptance range more than a predefined number of times.

According to another aspect of the invention, a method for testing the random numbers generated by a random-number generator includes the steps of: (a) generating a stream of random bits using the random-number generator; (b) applying the generated random bits to a gap length calculation operation; (c) applying the output of the gap-length operation to a functional exponential averaging to obtain a functional-average-gap length; (d) comparing the functional-average-gap length to a predetermined acceptance range; and, (e) determining whether the functional-average-gap length falls outside the predetermined acceptance range more than a predefined number of times. The method further includes the steps of: determining that the generated random bits are insufficiently random when the functional-average-gap length falls outside the predetermined acceptance range more than the predefined number of times, if the functional-average-gap length falls inside the predetermined acceptance range, repeating the steps (a)-(e) until the functional-average-gap length falls outside the predetermined acceptance range; notifying that insufficiently random numbers are generated when the steps (a)-(e) are repeated more than the predefined number of times; and, generating a new set of random numbers when the steps (a)-(e) are repeated more than the predefined number of times.

According to a further aspect of the invention, an apparatus for testing the random numbers generated by a random-number generator includes: means for generating random numbers comprising binary bits; means for detecting whether the generated random sequence is insufficiently random based on an exponential-functional-average gap length test; and, means for controlling the flow of the generated random sequences for a subsequent application when the generated random sequence is determined to be insufficiently random, wherein the exponential-functional-average gap length operation is performed to compute an average gap length between at least two occurrences of identical bit patterns and wherein, if the average gap length repeatedly falls outside a predetermined acceptance range more than a predefined number of times, determining that the generated random sequence is insufficiently random. The apparatus further includes means for transmitting an alarm signal that the generated random sequence is insufficiently random when the average gap length falls repeatedly outside the predetermined acceptance range more than the predefined number of times; and, means for generating a new set of random bits when the average gap length falls repeatedly outside the predetermined acceptance range more than the predefined number of times.

Yet another aspect is that the present invention may be implemented in hardware, software, or a combination of hardware and software as desired for a particular application.

Furthermore, the present invention may be realized in a simple, reliable, and inexpensive implementation.

These and other advantages will become apparent to those skilled in this art upon reading the following detailed description in conjunction with the accompanying drawings.

### BRIEF DESCRIPTION OF DRAWINGS

FIG. 1 illustrates a simplified block diagram of the random-number-generating module according to an embodiment of the present invention;

FIG. 2 shows a diagram illustrating the notion of the “gaps” on a sequence of random numbers according to an embodiment of the present invention; and,

FIG. 3 is a flow chart illustrating the operation steps of testing the statistics of the generated random numbers according to an embodiment of the present invention.

### DETAILED DESCRIPTION OF THE EMBODIMENT

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. For purposes of simplicity and clarity, detailed descriptions of well-known devices, circuits, and methods are omitted so as not to obscure the description of the present invention with unnecessary detail.

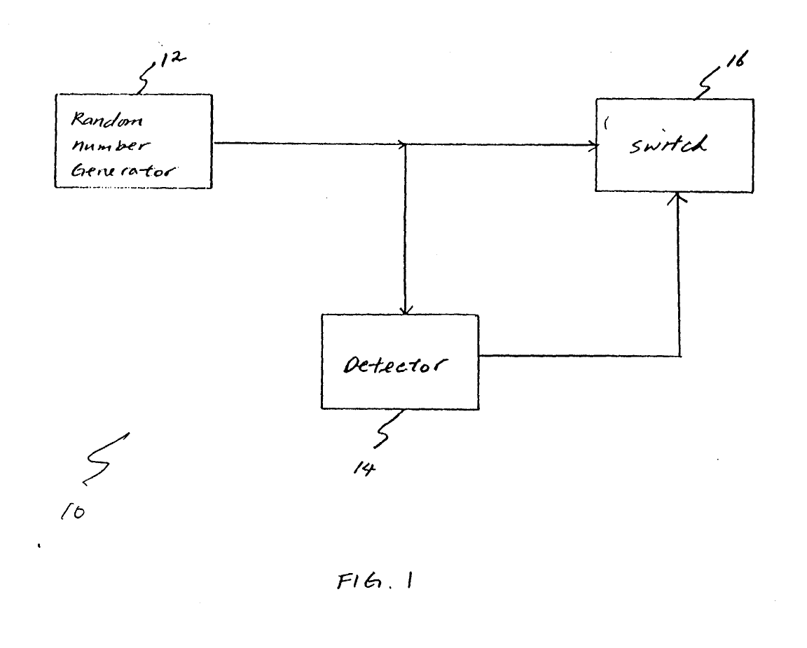

FIG. 1 illustrates a simplified block diagram of a random-number-generating system 10 according to an exemplary embodiment of the present invention. The system 10 includes a random-number generator (RG) 12 for generating a series of random numbers, a detector 14, and a switch 16. Note that the system 10 can be implemented by a variety of means in both hardware and software, and by a wide variety of controllers and processors. The RG 12 in this disclosure represents any device that produces a signal that can be converted to a sequence of binary bits, a Gaussian or any other distribution of signals, a sequence of signals representing a number between zero and one, a sequence of signals representing a decimal number, or any other form that includes the desired randomness. The switch 16 may represent an input to a cryptography system, an audio or video noise generator, a computer program, or other devices and processes.

In operation, RG 12 generates a continuous stream of random numbers during which the detector 14 detects whether the generated random numbers are truly random according to predetermined criteria (explained later). If they are determined to be sufficiently random within a predetermined acceptance level, the switch 16 allows the generated random numbers for a subsequent application, such as any circuit, system, process, gambling application, simulation, statistical sampling, Diffe-Hellman key exchanges, or the like which uses the random numbers supplied by the RG 12. Alternatively, a new set of random numbers may be generated if the generated random numbers are determined to be insufficiently random.

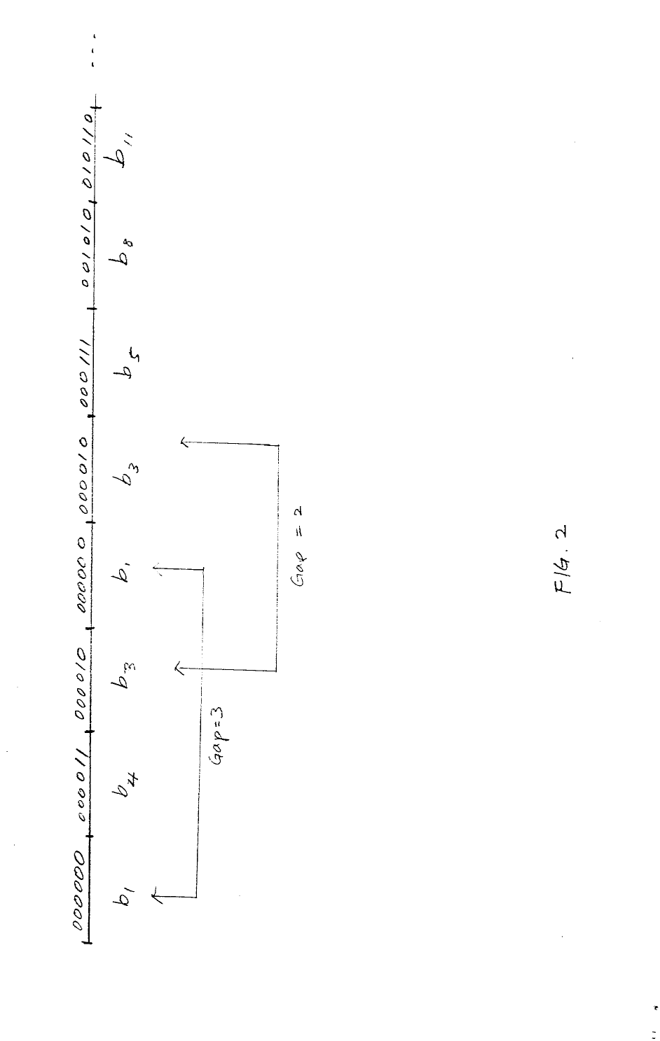

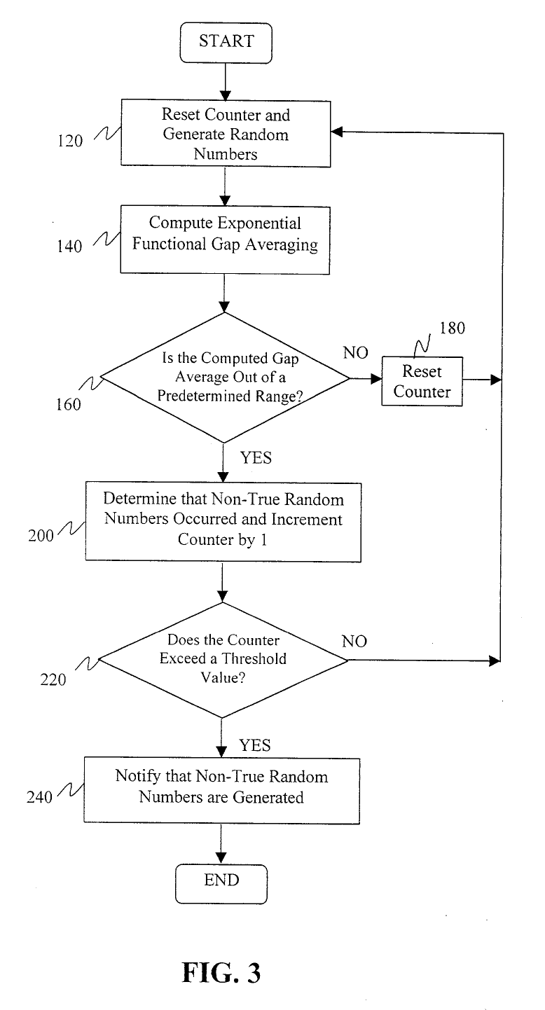

Now, a description will be made in detail in regards to determining whether the generated random numbers are sufficiently random with reference to FIGS. 2 and 3.

Referring to FIG. 2, the random numbers are tested in real time according to an embodiment of the present invention while the RG 12 is in operation to verify that the generated random numbers are sufficiently random. While processing the continuous stream of random bits generated by the RG 12, the detector 14 computes a functional-average of gaps between occurrences of the same bit patterns. It should be noted that there are various averaging methods that can be implemented in accordance with the techniques of the present invention; however, an exponential averaging is preferably used, as described below.

As shown in FIG. 2, each time a new random bit is processed, the new bit is appended to the sequence of previous bits until a predetermined number, k, bits are collected. There can be 2^{k} length-k bit patterns, and the gaps can be arbitrarily large between occurrences of identical gap patterns. FIG. 2 illustrates a group of 6 bit blocks as a unit of k=6 bits for illustrative purposes; however, it should be understood that the present invention can support any positive number of k bits. Thus, the grouping of 6 bits in the drawing should not impose limitations on the scope of the invention. A preferred value for k ranges from 6 to 16 bits.

An exponential average accumulator A is initialized to calculate the average function of the gap lengths between any two identical patterns of k bits. When a repeated occurrence of the same bit pattern is detected, the gap between the last occurrence and the preceding one is calculated. Individual gaps between occurrences of the same bit patterns can vary greatly, thus taking an average value gives a relatively stable measure of randomness. Note that if an average gap between occurrences of each different pattern must be monitored, it is necessary to use many counters or accumulators (A's). To save computational resources, all of the gaps between reoccurrences of different patterns are averaged in a single accumulator (A) in the embodiment of the present invention. The sensitivity of the test is greatly improved if such a function f of the gaps gets averaged instead of the gap lengths, which emphasizes the discrepancies between individual gap values. Large gap values occasionally appear in a perfectly random sequence as well, thus a natural requirement for f is that it must not put too much weight on the large gaps. Otherwise an occasional large gap would cause a perfectly random sequence to fail the test. Such f functions can be arbitrarily chosen. Two examples are the log function and the minimum function, min(x,m), with arbitrary parameter m.

In the embodiment, the functional gap-average-calculating process runs continuously. As such, the accumulator A must be cleared periodically to avoid overflow. To this end, an exponential averaging is utilized in the present invention, in which the accumulator A is decreased with a certain 0<α<1 factor before the averaging addition is performed, so it never becomes too large. That is, to save storage and execution time, exponential averaging to the functional-gap average calculations is applied in the present invention. The exponential averaging has the property that each time the average is updated in an accumulator A, the old averaged values will have a diminishing effect.

To have useful averaging effects, the value for a is selected to be close to 1, α=1−1/n, n>>1. In this case, log α≈−1/n and the half-life of the averaged values is k≈n·log 2≈0.30103·n. After n steps, the weight of the oldest averaged value becomes (1−1/n)ⁿ≈1/e≈0.367879. Here, e is the basis of the natural logarithm (the Euler constant), so the term, n, can be referred to as the natural life of the averaged values. If all values to be averaged were 1's, the accumulator value is 1+α+α²+ . . . =1/(1−α)=n, whereas if all bits were 0's the accumulator value is 0. Note that the expected value of the exponential average is the exponential average of the expected values of the individual random variables. If they are evenly distributed binary bits, the expected value is ½+½α+½α²+ . . . =n/².

The exponential-gap averaging according the embodiment of the present invention works in the following way. Each time a gap length value α is obtained, a factor, α, which falls between 0 and 1 (0<α<1), is multiplied to the accumulator A and then a weight function is applied to the gap length and the resulting value, f(x), is added to the accumulator: A_{new}=α·A_{old}+f(x), wherein x represents a current gap length. In one embodiment of the invention f(x) represents a minimum value between the current gap length and a predetermined constant value, m. The cut-off value, m, can be adjusted to selectively fine-tune the test for any particular requirement by the operator.

Once the exponential averaging is performed in the accumulator, the value of the exponential averaging accumulator A is compared to a predetermined acceptance range. That is, it is determined whether the generated random-number pattern will not be substantially random by comparing the value of the accumulator to the predetermined acceptance-range value. If the value of the accumulator falls out of the predetermined range value during the averaging process, it is inferred that the generated random numbers would not be sufficiently random. Here, a threshold value may be set to notify the user when the test fails repeatedly.

In the embodiment, the exact boundary can be selectively adjusted based on the data obtained from extensive simulations with a known, good source of random numbers, in which an ideal gap distribution can be obtained. Such random sequences are commercially available and can be downloaded, for example, from various web sources, including “www.fourmilab.ch/hotbits” and “lavarand.sgi.com.” Thus, the actual range used in the test is selectively set by an operator so that a choice can be made of different sensibilities as to whether the generated random sequence is predictable to an unauthorized party.

FIG. 3 is a flow chart illustrating the operation steps for testing the statistical quality of the random sequence in accordance with the present invention. The rectangular elements indicate computer-software instruction, whereas the diamond-shaped element represents computer-software instructions that affect the execution of the computer-software instructions represented by the rectangular blocks. Alternatively, the processing and decision blocks represent steps performed by functionally equivalent circuits such as a digital-signal-processor circuit or an application-specific-integrated circuit (ASIC). It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention.

As shown in FIG. 3, the randomness test processes a continuous stream of random binary bits generated by the random-number generator 12 in step 120. In step 140, the generated random bits undergo a functional-average-gap calculation, in which a functional-gap distribution between an identical bit pattern of a specified length is computed and updated. That is, each time a gap between the same bit pattern is found, the exponential-average-gap value is updated in accumulator A in step 140. Here, the previous exponential-average-functional-gap value is reduced by a factor α(0<α<1), then the gap length weighted by a function f added, as follows: A_{new}=α·A_{old}+f(x), such that the old, average-gap value will have a diminishing effect. Here the function f can be any function chosen by the operator. The simplest choice is f(x)=min(x, m), another useful one is f(x)=log(x).

Thereafter, the average functional-gap value after undergoing the exponential-averaging operation is compared to a predetermined acceptance range in step 160. If the value of the accumulator A is outside the predetermined acceptance range, it is determined that non-random patterns have been detected in step 200, and the counter is increased by 1. Otherwise, the counter is reset in step 180 and the control returns to step 120 of generating further random numbers. In step 220, if the value of the counter is greater than a threshold value, a notification that the generated random numbers are not sufficiently random is transmitted in step 240. Alternatively, the switch 16 can be deactivated to stop the flow of the random numbers for a subsequent application. Then, the generated random numbers can be discarded, and the whole process with generating new random numbers can be initiated. If the value of the counter does not exceed the threshold value in step 220, this step of generating random numbers is repeated.

The various steps described above may be implemented by programming them into functions incorporated within application programs, and programmers of ordinary skill in the field can implement them using customary programming techniques in languages, such as C, Visual Basic, Java, Perl, C++, and the like. In an exemplary embodiment, the method described in FIG. 3 may be constructed as follows (using the C programming language). For simplicity we implemented the test using floating-point arithmetic.

[image]

[image]

[image]

While the preferred embodiments of the present invention have been illustrated and described, it will be understood by those skilled in the art that various changes and modifications may be made and equivalents substituted for elements thereof without departing from the true scope of the present invention. In addition, many modifications can be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A method for testing randomness when generating a stream of random numbers, the method comprising the steps of:
generating a continuous stream of random binary bits;
applying said generated random bits to an exponential-functional-gap average calculation to compute a weighted average gap length between occurrences of at least two identical bit patterns; and,
determining whether said generated random bits are sufficiently random by comparing the output of said exponential-gap operation to a predetermined acceptance range.

2. The method of claim 1, wherein said predetermined acceptance range is selected by an operator to achieve a desired security-threshold level.

3. The method of claim 1, further comprising the step of determining that said generated random bits are insufficiently random when the average gap length repeatedly falls outside said predetermined acceptance range more than a predefined number of times.

4. The method of claim 1, further comprising the step of notifying that said generated random bits are insufficiently random when the average gap length repeatedly falls outside said predetermined acceptance range more than a predefined number of times.

5. The method of claim 1, further comprising the step of generating a new set of random bits when the average gap length repeatedly falls outside said predetermined acceptance range more than a predefined number of times.

6. The method of claim 1, further comprising the step of denying said generated random bits for a subsequent application when the average gap length repeatedly falls outside said predetermined acceptance range more than a predefined number of times.

7. A method for testing the random numbers generated by a random-number generator, the method comprising the steps of:
(a) generating a stream of random bits using said random-number generator;
(b) applying said generated random bits to a gap length operation;
(c) applying the output of said gap-length operation to a functional exponential averaging to obtain a functional-average-gap length;
(d) comparing the functional-average-gap length to a predetermined acceptance range; and,
(e) determining whether the functional-average-gap length falls outside said predetermined acceptance range more than a predefined number of times.

8. The method of claim 7, wherein said predetermined acceptance range is selected by an operator to achieve a desired security-threshold level.

9. The method of claim 7, further comprising the step of determining that said generated random bits are insufficiently random when the functional-average-gap length falls outside said predetermined acceptance range more than said predefined number of times.

10. The method of claim 7, further comprising the step of:
if the functional-average-gap length falls inside said predetermined acceptance range, repeating said steps (a)-(e) until the functional-average-gap length falls outside said predetermined acceptance range.

11. The method of claim 10, further comprising the step of notifying that insufficiently random numbers are generated when said steps (a)-(e) are repeated more than said predefined number of times.

12. The method of claim 7, further comprising the step of generating a new set of random numbers when said steps (a)-(e) are repeated more than said predefined number of times.

13. An apparatus for testing the random numbers generated by a random-number generator, comprising:
means for generating random sequences comprising binary bits;
means for detecting whether said generated random sequences are insufficiently random based on an exponential-functional-average gap length operation; and,
means for controlling the flow of said generated random sequences for a subsequent application when said generated random sequences are determined to be insufficiently random,
wherein said exponential-functional-average gap length operation is performed to compute an average gap length between at least two occurrences of identical bit patterns and wherein, if the average gap length repeatedly falls outside a predetermined acceptance range more than a predefined number of times, determining that said generated random sequences are insufficiently random.

14. The apparatus of claim 13, further comprising means for transmitting an alarm signal that said generated random sequences are insufficiently random when the average gap length falls repeatedly outside said predetermined acceptance range more than said predefined number of times.

15. The method of claim 13, further comprising means for generating a new set of random bits when the average gap length falls repeatedly outside said predetermined acceptance range more than said predefined number of times.

16. The apparatus of claim 13, wherein said predetermined acceptance range is selected by an operator to achieve a desired security-threshold level.

17. A machine-readable medium having stored thereon data representing sequences of instructions, and the sequences of instructions which, when executed by a processor, cause the processor to:
process a continuous stream of random binary bits generated by a random number generator;
apply said generated random bits to an exponential-functional-average gap length calculation to compute an average gap length between at least two occurrences of identical bit patterns; and,
determine whether said generated random bits are insufficiently random by comparing the output of said exponential-gap operation to a predetermined acceptance range.

18. The machine-readable medium of claim 17, wherein said predetermined acceptance range is selected by an operator to achieve a desired security-threshold level.

19. The machine-readable medium of claim 17, wherein said processor is further operative to determine that said generated random bits are insufficiently random when the average gap length falls repeatedly outside said predetermined acceptance range more than a predefined number of times.

20. The machine-readable medium of claim 17, wherein said processor is further operative to notify that said generated random bits are insufficiently random when the average gap length falls repeatedly outside said predetermined acceptance range more than a predefined number of times.

21. The machine-readable medium of claim 17, wherein said processor is further operative to process a new set of random bits when the average gap length repeatedly falls outside said predetermined acceptance range more than a predefined number of times.

22. The machine-readable medium of claim 17, wherein said processor is further operative to deny said generated random bits for a subsequent application when the average gap length repeatedly falls outside said predetermined acceptance range more than a predefined number of times.
